(19) United States
(12) Patent Application Publication
(10) Pub. No.: US 2011/0117914 A1
(43) Pub. Date: May 19, 2011

(54) METHOD AND APPARATUS FOR DEREGISTRATION OF PERSONAL NETWORK ELEMENT(PNE) IN 3GPP PERSONAL NETWORK(PN)

(75) Inventors: Mi Jeong YANG, Daejeon (KR); Soon Yong LIM, Daejeon (KR); Kyung-yul CHEON, Daejeon (KR); Hyeyeon KWON, Daejeon (KR); Aesoon PARK, Daejeon (KR)

(73) Assignee: Electronics and Telecommunications Research Institute, Daejeon (KR)

(21) Appl. No.: 12/942,716

(22) Filed: Nov. 9, 2010

(30) Foreign Application Priority Data
Nov. 12, 2009 (KR) 10-2009-0109118
Nov. 4, 2010 (KR) 10-2010-0109204

(51) Int. Cl. H04W 4/00

(52) U.S. Cl. 455/435.1

(57) ABSTRACT

Disclosed is a control method of user equipment (UE) to deregister a personal network element (PNE) in a personal network (PN), the control method including receiving a deregistration request message from the PNE via a personal area network (PAN) internal communication means in order to deregister the PNE registered to the PN and subordinate to the UE, transmitting a request message for deregistration of the PNE to a session control device controlling a session with respect to the PN in response to the deregistration request message, receiving a response message corresponding to the request message for deregistration of the PNE from the session control device, and transmitting the response message to the PNE via the PAN internal communication means in order to notifying deregistration of the PNE.

### CROSS-REFERENCE TO RELATED APPLICATION

This application claims the benefit of Korean Patent Application No. 10-2009-0109118, filed on Nov. 12, 2009, and No. 10-2010-0109204, filed on Nov. 4, 2010, the entire disclosure of which is incorporated herein by reference.

### BACKGROUND OF THE INVENTION

1. Field of the Invention

The present invention relates to a method and an apparatus for deregistration, and more particularly, to a method and an apparatus of deregistering a personal network element (PNE) in a third generation partnership project (3GPP) personal network (PN).

2. Description of the Conventional Art

In a third generation partnership project (3GPP), user equipment (UE) is managed through a personal network management (PNM) scheme for a personal network (PN) service. Here, management includes registration, deregistration, configuration, deconfiguration, query, and the like.

The PNM may include a personal network element (PNE) in addition to the UE.

Unlike the UE, the PNE does not perform independent management procedures but is controlled by the PNM through the UE. However, there is no method of deregistering the PNE, and thus a method of deregistering the registered PNE terminated in use is needed.

### SUMMARY OF THE INVENTION

An aspect of the present invention provides a method and an apparatus of deregistering a personal network element (PNE) in a third generation partnership project (3GPP) personal network (PN) through user equipment (UE).

According to an aspect of the present invention, there is provided a control method of UE to deregister a PNE in a PN, the control method including receiving a deregistration request message from the PNE via a personal area network (PAN) internal communication means in order to deregister the PNE registered to the PN and subordinate to the UE, transmitting a request message for deregistration of the PNE to a session control device controlling a session with respect to the PN in response to the deregistration request message, receiving a response message corresponding to the request message for deregistration of the PNE from the session control device, and transmitting the response message to the PNE via the PAN internal communication means in order to notifying deregistration of the PNE.

According to an aspect of the present invention, a control method of an session control device to deregister a PNE in a PN includes receiving a request message for deregistration of the PNE from UE communicating with the PNE registered to the PN, transmitting a response message corresponding to the request message for deregistration to the UE, transmitting a deregistration information message to a Personal Network Management Device managing the PN in response to the request message for deregistration based on an initial filter criteria stored and downloaded to the session control device when user registration to the PN is performed, and receiving a message notifying deregistration of the PNE from the Personal Network Management Device.

According to an aspect of the present invention, a control method of a Personal Network Management Device to deregister a PNE in a PN includes receiving a deregistration information message with respect to the PNE from an session control device based on an initial filter criteria stored and downloaded to the session control device when user registration to the PN is performed, the session control device receiving a request message for deregistration of the PNE from user equipment (UE) controlling the PNE registered to the PN, verifying deregistration of the PNE based on the deregistration information message, and transmitting a message notifying deregistration of the PNE to the session control device.

According to an aspect of the present invention, a UE to deregister a PNE in a PN includes a reception unit to receive a deregistration request message from the PNE in order to deregister the PNE registered to the PN and subordinate to the UE, a transmission unit to transmit a request message for deregistration to an session control device controlling a session with respect to the PN in response to the deregistration request message, an interface means to communicate with the PNE and the session control device, and a subscriber identification means to perform communication to control the PNE.

According to an aspect of the present invention, an session control device to deregister a PNE in a PN includes a reception unit to receive a request message for deregistration of the PNE from UE communicating with the PNE registered to the PN, and to receive a message notifying deregistration of the PNE from a Personal Network Management Device, a transmission unit to transmit a response message corresponding to the request message for deregistration to the UE, and to transmit a deregistration information message to the Personal Network Management Device managing the PN in response to the request message for deregistration based on an initial filter criteria stored and downloaded to the session control device in user registration to the PN, and a controller to control a session status between the PNE and the UE.

According to an aspect of the present invention, a Personal Network Management Device to deregister a PNE in a PN includes a reception unit to receive a deregistration information message with respect to the PNE from an session control device based on an initial filter criteria stored and downloaded to the session control device in user registration to the PN, the session control device receiving a request message for deregistration of the PNE from UE controlling the PNE registered to the PN, a deregistration unit to verify deregistration of the PNE based on the deregistration information message, and a transmission unit to transmit a message notifying deregistration of the PNE to the session control device.

As described above, according to an aspect of the present invention, a PNE registered and terminated in use in a 3GPP PN may be deregistered.

### BRIEF DESCRIPTION OF THE DRAWING

FIG. 1 illustrates a process of deregistering user equipment (UE) in a third generation partnership project (3GPP) personal network (PN) according to a related art;

FIG. 2 illustrates a process of deregistering a personal network element (PNE) in a 3GPP PN according to an embodiment of the present invention;

FIG. 3 is a flowchart illustrating a control method of UE according to an embodiment of the present invention;

FIG. 4 is a flowchart illustrating a control method of a session control device according to an embodiment of the present invention;

FIG. 5 is a flowchart illustrating a control method of a Personal Network Management Device according to an embodiment of the present invention;

FIG. 6 is a block diagram of UE according to an embodiment of the present invention;

FIG. 7 is a block diagram of a session control device according to an embodiment of the present invention; and

FIG. 8 is a block diagram of a Personal Network Management Device according to an embodiment of the present invention.

### DETAILED DESCRIPTION OF THE PREFERRED EMBODIMENT

Exemplary embodiments of the present invention are described below to explain the present invention by referring to the accompanying drawings.

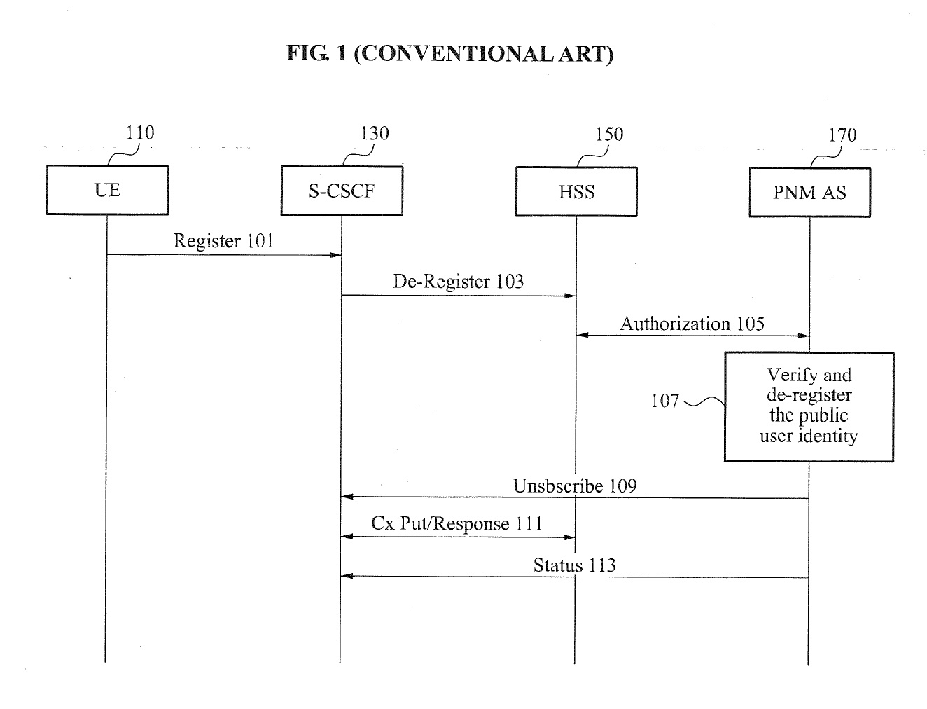

FIG. 1 illustrates a process of deregistering user equipment (UE) in a third generation partnership project (3GPP) personal network (PN) according to a related art.

Referring to FIG. 1, the UE 110 which is registered and terminated in use transmits a Register for deregistration to a session control 130 in operation 101. The session control device 130 may be expressed as a servicing call session control function (S-CSCF).

The session control device 130 registers a De-Register requesting deregistration to a home subscriber server (HSS) 150 in operation 103. The HSS 150 receives an Authorization for deregistration from the Personal Network Management Device 170 based on the De-Register requesting deregistration in operation 105. Personal Network Management Device may be expressed as a personal network management access system (PNM AS).

The Personal Network Management Device 170 verifies the UE 110 requesting deregistration and deregisters a public user identity allocated to the UE 110.

Then, the Personal Network Management Device 170 unsubscribes the UE 110 from the session control device 130 in operation 109.

The HSS 150 receives a Cx-Put/Response, from the session control device 130, reporting that infatuation about the UE 110 requesting deregistration is deleted in operation 111.

The Personal Network Management Device 170 terminates deregistration of the UE 110 registered and terminated in use through operations 101 to 111, and then performs another process in operation 113.

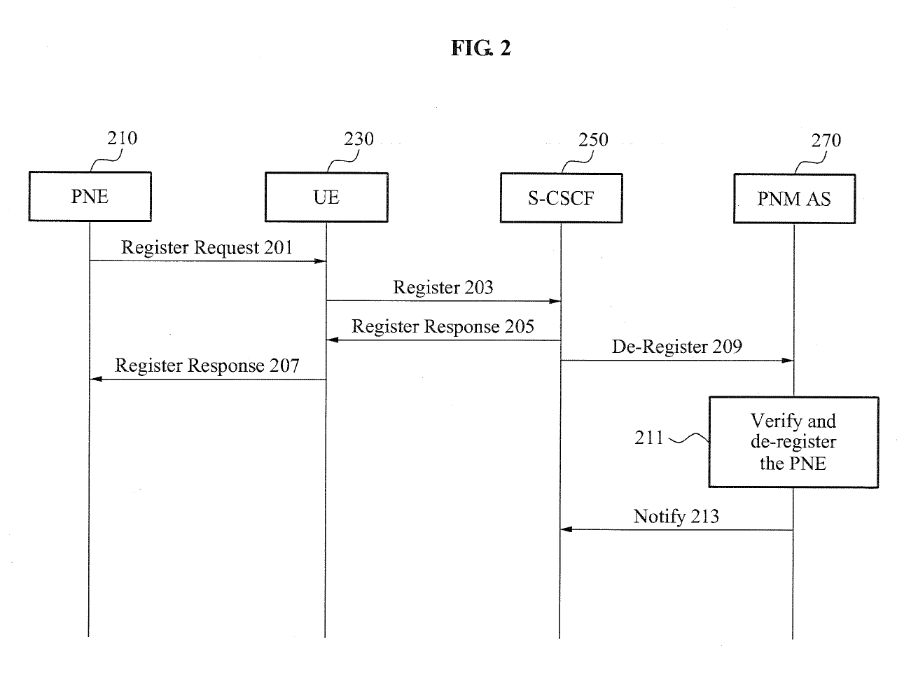

FIG. 2 illustrates a process of deregistering a personal network element (PNE) in a 3GPP PN according to an embodiment of the present invention.

Referring to FIG. 2, the 3GPP PN includes the PNE 210, UE 230, an session control device 250, and a Personal Network Management Device 270.

The PNE 210 may not be an independent component of the Personal Network Management Device 270 but may depend on the UE 230 to perform at least one of registration, deregistration, configuration, deconfiguration, and query. Thus, the PNE 210 transmits a Register_Request deregistration to the UE 230 via a personal area network (PAN) internal communication means in order to deregister the PNE 210 in operation 201.

The UE 230 may independently perform at least one of registration, deregistration, configuration, deconfiguration, and query. The UE 230 communicates with the PNE 210 and the session control device 250 to control the PNE 210. The UE 230 receiving the Register_Request transmits a Register for deregistration of the PNE 210 to the session control device 250 controlling a session with respect to a PN in operation 203. The session control device 250 transmits a Register_Response corresponding to the Register for deregistration to the UE 230 in operation 205.

The UE 230 transmits the Register_Response to the PNE 210 via the PAN internal communication means in order to report that the PNE 210 is deregistered in operation 207.

The session control device 250, receiving the Register for deregistration from the UE 230, transmits a De-Register to the Personal Network Management Device 270 managing the PN in operation 209.

The Personal Network Management Device 270, receiving the De-Register, deregisters the PNE 210 via a verification in operation 211. Then, the Personal Network Management Device 270 transmits a ‘Notify’ notifying deregistration of the PNE 210 to the session control device 250, and notifies the session control device 250 that deregistration of the PNE 210 terminates in operation 213.

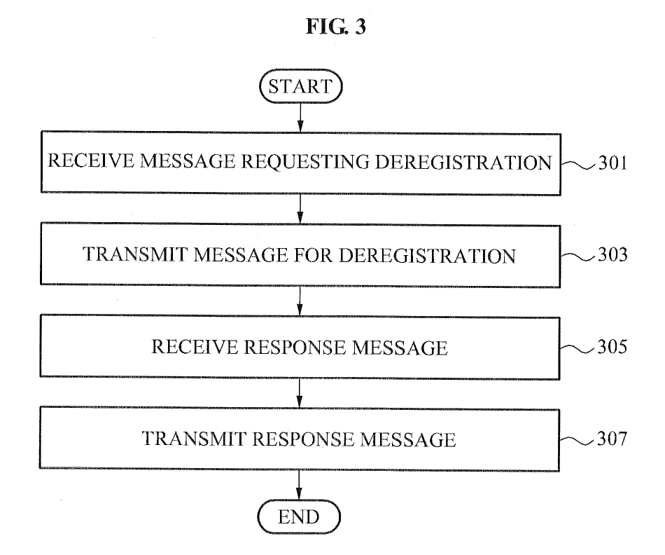

FIG. 3 is a flowchart illustrating a control method of UE according to an embodiment of the present invention.

Referring to FIG. 3, the UE to deregister a PNE in a PN receives a deregistration request message from the PNE via a PAN internal communication means in order to deregister the PNE registered to the PN and terminated in use in operation 301.

The UE transmits a request message for deregistration of the PNE to session control device controlling a session with respect to the PN in response to the deregistration request message in operation 303.

The UE may transmit the request message for deregistration containing an expiration value of zero seconds.

Then, the UE receives, from the session control device, a response message corresponding to the request message for deregistration in operation 305.

The UE transmits the response message to the PNE via the PAN internal communication means in order to report that the PNE is deregistered in operation 307.

Here, the PNE may be subordinate to the UE. Unlike the UE, the PNE may not perform registration, deregistration, configuration, deconfiguraiton, query, and the like, independently.

Thus, the PNE is managed or controlled by the UE to perform the above processes.

Here, the UE communicates with the PNE and the session control device to control the PNE.

A relation between the UE and the PNE is described with the following example.

There is a case where a user having a personal digital assistant (PDA), a laptop, two communication terminals, a music player, a headset, and the like goes out, carrying only one communication terminal.

When the user positioned outside desires to check out information, such as emails, received by the PDA and the other communication terminal which are left at home using the currently carried communication terminal, the user may turn on the PDA and the other communication terminal through a 3GPP communication. Then, the user may receive emails and other information received by the PDA and the other communication terminal to the communication terminal currently carried.

Here, the communication terminal currently carried by the user may be the UE. The PDA, the laptop, and the other communication terminal left at home may be the PNE.

Here, the PNE may include a component to perform communication, such as Bluetooth, WiFi, and wired-based communication, but may not include an interface component to communicate with the PNE and the session control device.

On the contrary, the UE may include an interface component to communicate with the PNE and the session control device, and a component to control the PNE.

Thus, the PNEs which the user leaves at home may be subordinate to the communication terminal currently carried by the user, that is, the UE.

In addition, the PNEs subordinate to the UE may include the music player, a camera, the headset, or the like.

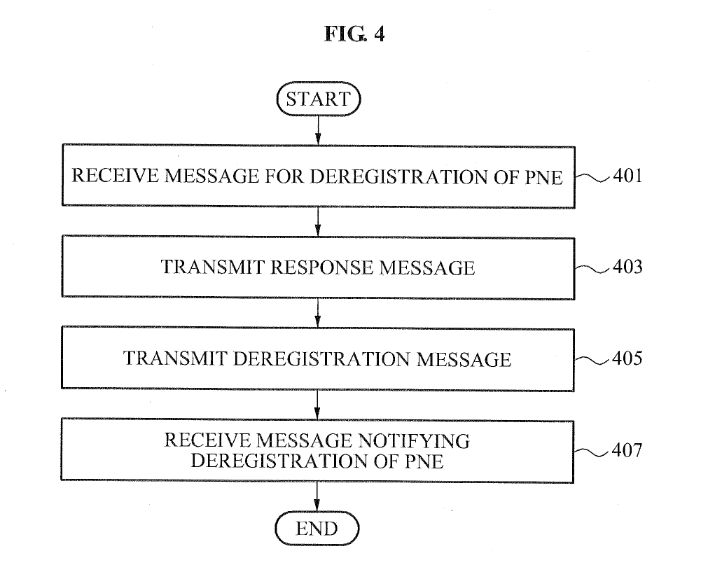

FIG. 4 is a flowchart illustrating a control method of a session control device according to an embodiment of the present invention.

Referring to FIG. 4, the session control device to deregister a PNE in a PN receives a request message for deregistration of the PNE from UE communicating with the PNE registered to the PN in operation 401.

The session control device transmits, to the UE, a response message corresponding to the request message for deregistration in operation 403.

The session control device transmits a deregistration information message to a Personal Network Management Device managing the PN in response to the request message for deregistration based on an initial filter criteria stored and downloaded to the session control device in user registration to the PN in operation 405.

Here, the Personal Network Management Device may verify deregistration of the PNE based on the deregistration information message.

The PNE may perform at least one of registration, deregistration, configuration, deconfiguration, and query, depending on the UE.

The PNE receives, from the Personal Network Management Device, a message to notifying deregistration of the PNE in operation 407.

In the control method of the session control device session control device, a relation between the PNE and the UE is the same as in the description with reference to FIG. 3, and descriptions thereof are omitted herein.

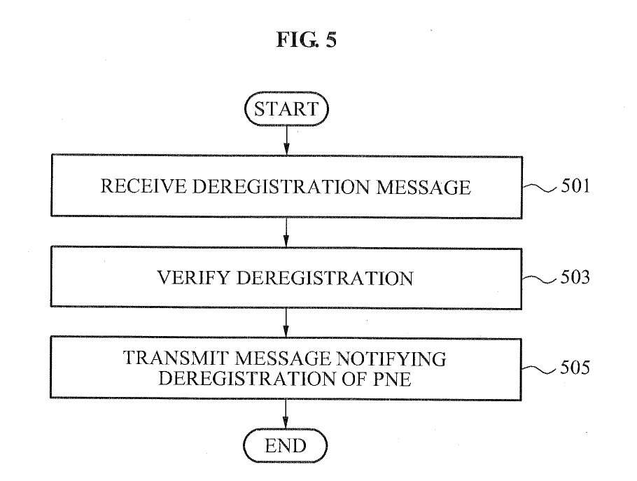

FIG. 5 is a flowchart illustrating a control method of a Personal Network Management Device according to an embodiment of the present invention.

Referring to FIG. 5, the Personal Network Management Device to deregister a PNE in a PN receives a deregistration information message from a session control device in operation 501.

Here, the session control device receives a request message for deregistration of the PNE from UE controlling the PNE registered to the PN.

The Personal Network Management Device verifies deregistration of the PNE based on the deregistration information message in operation 503.

The Personal Network Management Device compares an identifier of the PNE with other identifiers received from the session control device to verify the deregistration of the PNE from the PN.

Further, the Personal Network Management Device may register the identifier of the PNE as deregistered from a database based on the verification of the deregistration of the PNE, and eliminate information about configuration settings associated with the identifier of the PNE stored in the database.

The Personal Network Management Device may simultaneously verify the deregistration of the PNE and deregister the PNE.

However, the deregistration by the Personal Network Management Device may be achieved by various deregistration processes used for general communication apparatuses, and descriptions thereof are omitted.

The Personal Network Management Device transmits, to the session control device, a message to notifying the deregistration of the PNE in operation 505, and notifies the session control device that the deregistration of the PNE is terminated through the message. Here, the information flow notification may include information about a registration status of the PNE. In the control method of the Personal Network Management Device, a relation between the PNE and the UE is the same as in the description with reference to FIG. 3, and descriptions thereof are omitted herein.

The above-described methods may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

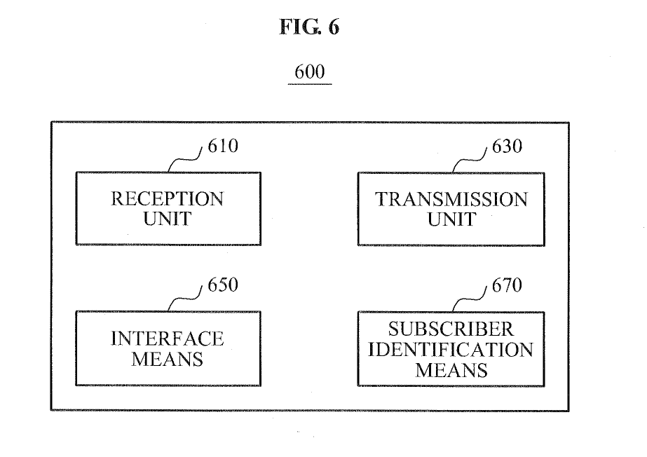

FIG. 6 is a block diagram of UE 600 according to an embodiment of the present invention. Referring to FIG. 6, the UE 600 to deregister a PNE in a PN includes a reception unit 610, a transmission unit 630, an interface means 650, and a subscriber identification means 670.

The reception unit 610 receives a deregistration request message from the PNE in order to deregister the PNE registered to the PN and subordinate to the UE 600.

Further, the reception unit 610 may receive a response message corresponding to a request message for deregistration from a session control device.

The transmission unit 630 transmits the request message for deregistration to the session control device controlling a session with respect to the PN in response to the deregistration request message.

The transmission unit 630 may transmit the request message for deregistration to the SESSION CONTROL DEVICE using an expiration value of zero seconds.

Moreover, the transmission unit 630 may transmit the response message, received from the SESSION CONTROL DEVICE, to the PNE via a PAN internal communication means in order to report that the PNE is deregistered.

The interface means 650 communicates with the PNE and the SESSION CONTROL DEVICE.

The subscriber identification means 670 performs communication to control the PNE.

Here, the subscriber identification means 670 may, for example, use a subscriber identity module (SIM) or a universal subscriber identity module (USIM).

The SIM is a card-type module used in a mobile phone and stores personal information in order to provide various services, such as authentication services, fee charging services, security functions, and the like, to a subscriber.

The USIM is a chip inserted into a Wideband Code Division Multiple Access (WCDMA)-based terminal, and serves as both the SIM for user authentication and the Universal Integrated Circuit Card (UICC) including functions of transportation cards or credit cards.

Here, the UICC may guarantee integrity and security of all personal information and data through support of various multi-applications for security.

The USIM includes a small central processing unit (CPU) and a memory, wherein the CPU identifies users through encoding and decoding, and the memory may be used to store optional services.

The PNE may be subordinate to the UE 600, which refers to the relation between the UE 600 and the PNE described above with reference to FIG. 3.

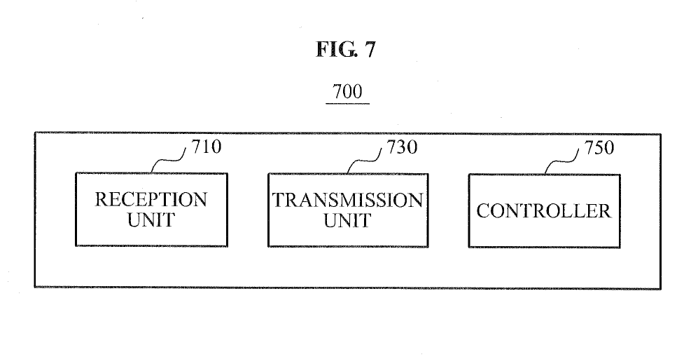

FIG. 7 is a block diagram of a session control device 700 according to an embodiment of the present invention. Referring to FIG. 7, the session control device 700 to deregister a PNE in a PN includes a reception unit 710, a transmission unit 730, and a controller 750.

The reception unit 710 receives a request message for deregistration of the PNE'from UE communicating with the PNE registered to the PN.

Further, the reception unit 710 may receive a message to notifying deregistration of the PNE from a Personal Network Management Device subordinate to the UE.

The transmission unit 730 transmits a response message corresponding to the request message for deregistration to the UE.

Further, the transmission unit 730 may transmit a deregistration information message to the Personal Network Management Device managing the PN in response to the request message for deregistration based on an initial filter criteria stored and downloaded to the session control device 700 in user registration to the PN.

The controller 750 controls a session status between the PNE and the UE.

In addition, the controller 750 may maintains the session status or manage information about a user.

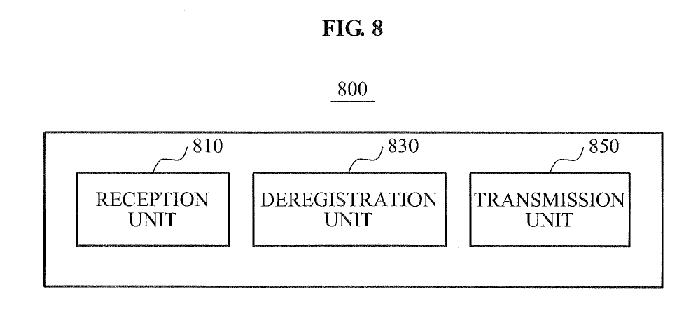

FIG. 8 is a block diagram of a. Personal Network Management Device according to an embodiment of the present invention. Referring to FIG. 8, the Personal Network Management Device 800 to deregister a PNE in a PN includes a reception unit 810, a deregistration unit 830, and a transmission unit 850.

The reception unit 810 receives a deregistration information message from a session control device.

Here, the session control device receives a request message for deregistration of the PNE from UE controlling the PNE registered to the PN.

Here, the PNE may be subordinate to the UE. The UE may include a subscriber identification means communicating with the PNE and session control device to control the PNE.

The subscriber identification means may, for example, use an SIM or a USIM, described above.

The deregistration unit 830 verifies deregistration of the PNE based on the deregistration information message.

The deregistration unit 830 compares an identifier of the PNE with other identifiers received from the session control device to verify the deregistration of the PNE in the PN.

Further, the deregistration unit 830 may register the identifier of the PNE as deregistered from a database based on the verification of the deregistration of the PNE, and eliminate information about configuration settings associated with the identifier of the PNE stored in the database.

The transmission unit 850 transmits a message to notifying the deregistration of the PNE to the session control device. Further, the transmission unit 850 may transmit, to the session control device, an information flow notification to notifying the deregistration of the PNE. The information flow notification may include information about a registration status of the PNE.

Although omitted, the above description about the control methods of the components to deregister the PNE in the PN with reference to FIGS. 2 to 5 may be applied to the components to deregister the PNE in the PN described with reference to FIGS. 6 to 8.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1-20. (canceled)

21. A control method of user equipment (UE) to deregister a personal network element (PNE) from a personal network (PN), the control method comprising:
receiving a deregistration request message from the PNE;
transmitting a request message for deregistration of the PNE to a session control device controlling a session with respect to the PN in response to the deregistration request message;
receiving a response message corresponding to the request message for deregistration of the PNE from the session control device; and
transmitting a deregistration response message corresponding to the response message to the PNE.

22. The control method of claim 21, wherein the request message for deregistration of the PNE is a register message with an expiration value of zero seconds.

23. The control method of claim 21, wherein the UE performs at least one of registration, deregistration, configuration, deconfiguration, and query, independently of the PNE.

24. A control method of a session control device to deregister a personal network element (PNE) from a personal network (PN), the control method comprising:
receiving a request message for deregistration of the PNE from user equipment (UE) communicating with the PNE;
transmitting a response message corresponding to the request message for deregistration to the UE;
transmitting a deregistration information message to a personal network management device managing the PN in response to the request message for deregistration; and
receiving a message notifying completion of deregistration of the PNE from the personal network management device.

25. The control method of claim 24, wherein the deregistration information message is transmitted to the personal network management device based on an initial filter criteria, the initial filter criteria being downloaded to the session control device when a user of the PN is registered.

26. The control method of claim 24, wherein the PNE performs at least one of registration, deregistration, configuration, deconfiguration, and query, dependently on the UE.

27. The control method of claim 24, wherein the UE performs at least one of registration, deregistration, configuration, deconfiguration, and query, independently of the PNE.

28. A control method of a personal network management device to deregister a personal network element (PNE) from a personal network (PN), the control method comprising:
receiving a deregistration information message for the PNE from a session control device controlling a session with respect to the PN;
performing deregistration of the PNE based on the deregistration information message; and
transmitting a message notifying completion of deregistration of the PNE to the session control device.

29. The control method of claim 28, wherein the deregistration information message is received from the session control device based on an initial filter criteria, the initial filter criteria being downloaded to the session control device when a user of the PN is registered.

30. The control method of claim 28, wherein the performing of the deregistration of the PNE comprises comparing an identifier of the PNE with other identifiers received from the session control device.

31. The control method of claim 30, further comprising:
registering the identifier of the PNE as deregistered from a database based on a verification of the deregistration of the PNE; and
removing information about configuration settings associated with the identifier of the PNE stored in the database.

32. The control method of claim 30, wherein an notification information flow notifying the deregistration of the PNE is transmitted to the session control device,
wherein the notification information flow includes information regarding a registration status of the PNE.
